(19) United States
(12) Patent Application Publication
(10) Pub. No.: US 2014/0143861 A1
(43) Pub. Date: May 22, 2014

(54) COMPUTER WITH SAFEGUARD FUNCTION

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: XIN-SHU WANG, Shenzhen (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/779,755

(22) Filed: Feb. 28, 2013

(30) Foreign Application Priority Data
Nov. 20, 2012 (CN) 2012104728875

(51) Int. Cl. G06F 21/35

(52) U.S. Cl. CPC G06F 21/35
USPC 726/19

(57) ABSTRACT

A computer includes a storage unit, a communication unit, and a processor. The storage unit stores a password. The communication unit communicates the computer with a portable communication device. The processor includes a starting control module. During the booting up of the computer, when a password received by the communication unit from the portable communication device matches with the password stored in the storage unit, the starting control module controls the computer to start normally.

### BACKGROUND

1. Technical Field

The present disclosure relates to computers and, particularly, to a computer having a safeguard function.

2. Description of Related Art

Passwords can be used to protect computers. Normally, after a computer has been successfully started, and a correct user name and password are input, an access to the computer is granted. As a password can be easily figured out merely by observing how the password is input, the computer may not be very safe. Therefore, a computer with a safeguard function is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a computer, in accordance with an exemplary embodiment.

FIG. 2 is a block diagram of function modules of a processor of the computer of FIG. 1, in accordance with an exemplary embodiment.

### DETAILED DESCRIPTION

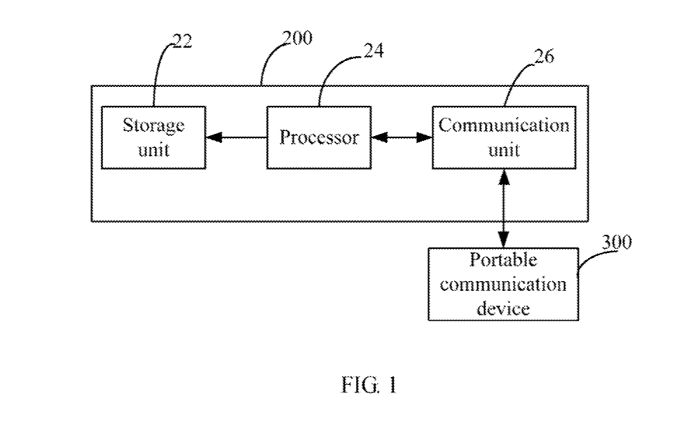

FIG. 1 is an embodiment of a computer 200. The computer 200 includes a storage unit 22, a processor 24, and a communication unit 26. The communication unit 26 is used to communicate between the computer 200 and a portable communication device 300, such as a mobile phone. In this embodiment, the communication unit 26 may be a Bluetooth unit or a Network Field Communication (NFC) unit. The storage unit 22 stores a password for control the starting of the computer 200. In this embodiment, the stored password is the Media Access Control (MAC) address of the portable communication device 300. During the booting up of the computer 200, when the computer 200 receives the MAC address of the portable communication device 300, the computer 200 can be normally started. Otherwise, the computer 200 cannot be normally started. In other words, during the booting up of the computer 200, if the portable communication device 300 is placed within a communication range between the computer 200 and the portable communication device 300, and a communication unit (not shown), such as a Bluetooth unit or an NFC unit, of the portable communication device 300 is opened, and the MAC address of the portable communication device 300 is sent to the computer 200, the computer 200 can be normally started.

With such configuration, during the booting up of the computer 200, only when the computer 200 receives the MAC address of the portable communication device 300, the computer 200 can be normally started, and an access to the computer 200 is granted. As the MAC address of the portable communication device 300 is not easily obtained by others, using the MAC address of the portable communication device 300 to control starting of the computer 200 can ensure the security of the computer 200.

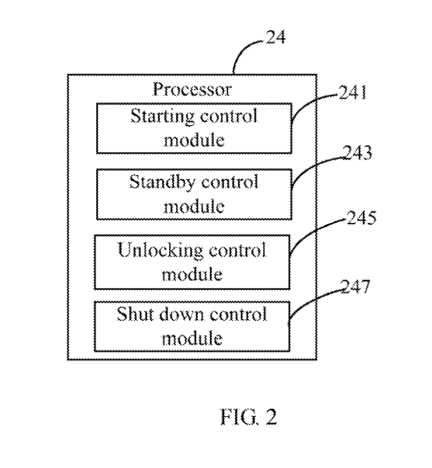

Referring to FIG. 2, the processor 24 includes a starting control module 241, a standby control module 243, an unlocking control module 245, and a shut down control module 247.

During the booting up of the computer 200, when the communication unit 26 receives the MAC address of the portable communication device 300, the starting control module 241 controls the computer 200 to start normally.

After the computer 200 has been normally started, when the communication between the communication unit 26 and the portable communication device 300 is interrupted, the standby control module 243 controls the computer 200 to enter a standby mode, and further locks the computer 200 by employing the MAC address stored in the storage unit 22.

After the computer 200 has been locked, when the communication unit 26 receives the MAC address of the portable communication device 300, the unlocking control module 245 unlocks the computer 200.

After the computer 200 has been normally started, when the communication unit 26 receives a shut down signal from the portable communication device 300, the shut down control module 247 shuts down the computer 200.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A computer comprising:
a storage unit storing a password;
a communication unit to communicate the computer with a portable communication device; and
a processor comprising a starting control module, during the booting up of the computer, when a password received by the communication unit from the portable communication device matches with the password stored in the storage unit, the starting control module being to control the computer to start normally.

2. The computer as described in claim 1, wherein the processor further comprises a standby control module, when the communication between the communication unit and the portable communication device is interrupted after the computer has been started normally, the standby control module is to control the computer to enter a standby mode and lock the computer using the password stored in the storage unit.

3. The computer as described in claim 2, wherein the processor further comprises an unlocking control module, when a password received by the communication unit from the portable communication device matches with the password stored in the storage unit after the computer has been locked, the unlocking control module is to unlock the computer.

4. The computer as described in claim 1, wherein the processor further comprises a shut down control module, when the communication unit receives a shut down signal from the portable communication device after the computer has been started normally, the shut down control module is to shut down the computer.

5. The computer as described in claim 1, wherein the password stored in the storage unit is a MAC address of the portable communication device.

6. The computer as described in claim 1, wherein the communication unit is a Bluetooth unit.

7. The computer as described in claim 1, wherein the communication unit is a Near Field Communication unit.
